(19) United States
(12) Patent Application Publication
(10) Pub. No.: US 2017/0344917 A1
(43) Pub. Date: Nov. 30, 2017

(54) OPERATION SPECIFICATION REPRODUCTION SYSTEM AND OPERATION SPECIFICATION REPRODUCTION METHOD

(71) Applicant: HITACHI, LTD., Tokyo (JP)

(72) Inventors: Ryota MIBE, Tokyo (JP); Hirofumi DANNO, Tokyo (JP); Hideaki ITO, Tokyo (JP); Tadashi TANAKA, Tokyo (JP); Yuichiro NAKAGAWA, Tokyo (JP)

(73) Assignee: HITACHI, LTD., Tokyo (JP)

(21) Appl. No.: 15/524,786

(22) PCT Filed: Jan. 22, 2016
(86) PCT No.: PCT/JP2016/051794

§ 371 Date: May 5, 2017

(30) Foreign Application Priority Data
Jan. 26, 2015 (JP) 2015-012164

(51) Int. Cl. G06Q 10/06; G06F 9/44

(52) U.S. Cl. CPC G06Q 10/0633; G06F 9/44

(57) ABSTRACT

An operation specification reproduction system includes: a case flowchart generation unit generating, on the basis of operation log data comprising records of necessary operations performed by persons in charge in order to execute respective cases, a case flowchart showing flows of operations performed by the persons in charge; a template generation unit for generating, on the basis of department data indicating association between responsible departments and the operations and the case flowchart generated by the case flowchart generation unit, an operation hierarchy template showing relationship between the responsible departments and the operations AA Discontinuity between persons in charge; and an operation flowchart generation unit for generating, on the basis of the operation hierarchy template and department template generated by the template generation unit, an operation flowchart showing the flows of operations performed by each department.

### TECHNICAL FIELD

The present invention relates to an operation specification reproduction system and an operation specification reproduction method.

### BACKGROUND ART

In migration from a former system to a new system, system development (replace development) according to its replace is required. In the replace development, there is a case where the new system overwrites most of specifications of the former system and precise documents of the former system are seldom left. In such a case, the specifications of the former system are reproduced by analyzing a source of the former system. However, even if the specifications at a system level can be reproduced from the source, the reproduction of the specifications at an operation level is often difficult. Accordingly, heretofore, the specifications at the operation level are often reproduced on the basis of hearing from a user and documents such as a procedure manual, but the precise specifications cannot be grasped because of reasons including the user's subjectivity and failure to maintain the procedure manual.

In view of such a problem, for example, in Patent Literature 1, page transition is automatically acquired by recursively executing a procedure for acquiring a Web page using specified URL for a starting point, capturing a screen, extracting a link included in the page and acquiring a linked page. In addition, in Patent Literature 2, an operation flow corresponding to an individual operation on the basis of processing time of a similar image of the following set of log records and an attribute such as user information is estimated by storing ID of a user who instructs a printer or a multi-function printer to print and an image log showing an image of a printed document and acquiring the set of log records belonging to the same individual operation on the basis of comparison of image logs included in a log record group registered on the basis of the abovementioned information.

### CITATION LIST

### Patent Literature

Patent Literature 1: Japanese Unexamined Patent Application Publication No. 2010-79342

Patent literature 2: Japanese Unexamined Patent Application Publication No. 2009-224958

### SUMMARY OF INVENTION

### Technical Problem

However, according to the technique disclosed in Patent Literature 1, specifications of a system called a screen transition diagram can be reproduced. However, Patent Literature 1 has a problem that it cannot be extracted what these mean in an operation and how they are used in an actual operation. In addition, according to the technique disclosed in Patent Literature 2, a flow of an operation is estimated on the basis of difference of whether a seal of approval of a similar document is put or not. However, Patent Literature 2 has a problem that a flow cannot be traced in operations greatly different in a document form (for example, between a list and a cutform).

The present invention is made in view of the abovementioned problems and its object is to provide an operation specification reproduction system and an operation specification reproduction method respectively enabling extracting department-level and role-level interactions between persons and a system from a log of the system.

### Solution to Problem

The operation specification reproduction system according to the present invention for settling the abovementioned problems has a characteristic that the operation specification reproduction system is provided with a case flowchart generation unit that generates a case flowchart showing a flow of an operation performed by a person in charge of a case on the basis of operation log data which is a record of operation of each person in charge of the operation required for executing the case, a template generation unit that generates an operation hierarchy template showing relation between a department and the operation and a department template showing relation between the department and the person in charge on the basis of department data correlating the department of the operation with the operation and the case flowchart generated by the case flowchart generation unit, and an operation flowchart generation unit that generates an operation flowchart showing a flow of the operation of each department on the basis of the operation hierarchy template and the department template respectively generated by the template generation unit.

Further, the present invention also discloses an operation specification reproduction method performed in the operation specification reproduction system.

### Advantageous Effects of Invention

According to the present invention, department-level and role-level interactions between persons and the system can be extracted from a log of the system.

### BRIEF DESCRIPTION OF DRAWINGS

FIG. 1 An example of a configuration of an operation specification reproduction system provided with an operation specification reproduction device.

FIG. 2 An example of an operation log stored in a storage.

FIG. 3 An example of a case flowchart generated by a case flowchart generation unit.

FIG. 4 A flowchart showing a procedure for a case flowchart generation process generated according to the case flowchart.

FIG. 5 An example of an operation hierarchy chart template generated by a template generation unit.

FIG. 6 An example of a department chart template generated by the template generation unit.

FIG. 7 An example of the operation hierarchy chart template generated by the template generation unit (when departments in charge are recorded).

FIG. 8 An example of the department chart template generated by the template generation unit (when departments in charge are recorded).

FIG. 9 An example of an operation flowchart at a screen level.

FIG. 10 An example of an operation flowchart at an operation level.

### DESCRIPTION OF EMBODIMENTS

Referring to the attached drawings, an embodiment of an operation specification reproduction system and an operation specification reproduction method according to the present invention will be described in detail below.

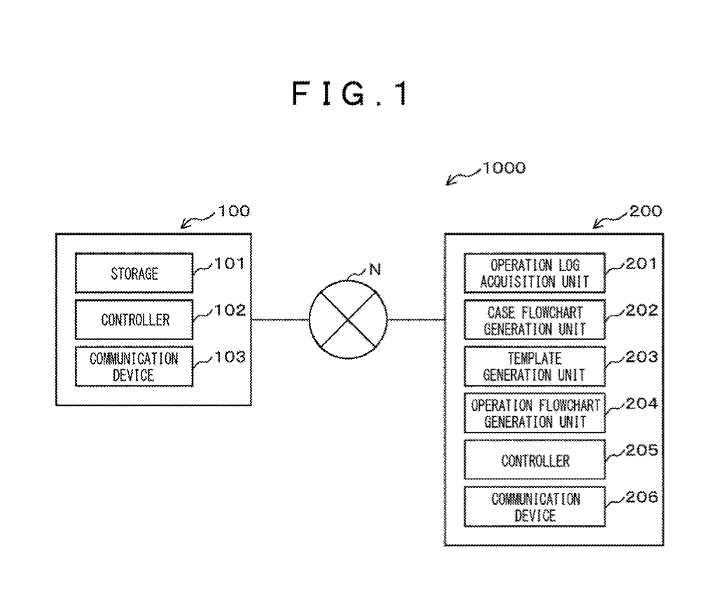

FIG. 1 shows an example of a configuration of the operation specification reproduction system 1000 provided with an operation specification reproduction device. As shown in FIG. 1, the operation specification reproduction system 1000 is provided with an object server 100 for holding an operation log of a former system the operation specifications of which are to be reproduced and an analysis server 200 for generating a final operation flow on the basis of the operation log received from the object server 100, and these servers are connected via a network N. The network N is a general communication line network such as the Internet.

The object server 100 is configured by a general server and is provided with a storage 101, a controller 102 and a communication device 103. The storage 101 is a general storage such as a HDD (hard disk drive) and stores an operation log of operations in the former system.

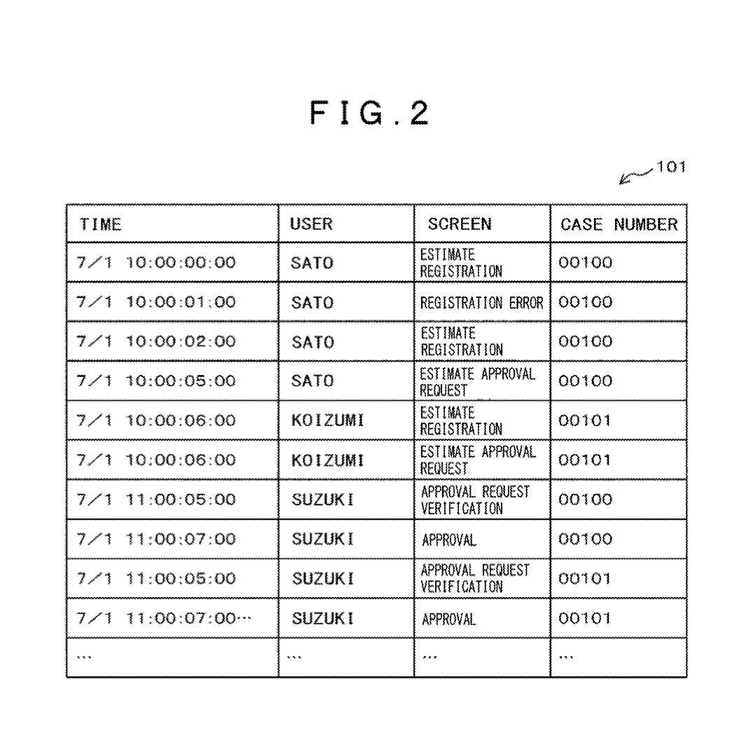

FIG. 2 shows an example of an operation log stored in the storage 101. As shown in FIG. 2, for the operation log, time when a user operates the former system, the user, a screen operated by the user and a case number of an operation identified by the operation or the screen are stored with them correlated. For example, FIG. 2 shows that Mr. or Ms. Sato who was a user registered an estimate of a case identified by a case number 00100 on an estimate registration screen at 10:00 on July 1, registration of the estimate was turned an error at 10:01 on the same day and a registration error screen was displayed on a display of an operation terminal connected to the object server 100, further, the estimate was registered on the estimate registration screen again at 10:02 on the same day, the registration of the estimate was completed at 10:05 on the same day, and FIG. 2 shows that an approval of the estimate was requested on an estimate approval screen. FIG. 2 shows that Mr. or Ms. Suzuki who was a user verified the estimate approval request on an approval request verification screen at 11:05 on July 1 and approved the estimate approval request on an approval screen at 11:07 on the same day. Although concrete description will be made later, as described above, an operation log acquisition unit 201 of analysis server 200 acquires the operation log stored in the object server 100.

The controller 102 is a general arithmetic unit such as a central processing unit (CPU), controls over storing information input from the operation terminal connected to the object server 100 and operated by the user in the operation log, and controls operation of each unit of the object server 100.

The communication device 103 is general communication equipment such as a NIC (network interface card), and transmits and receives various information between the operation terminal and the analysis server 200.

The analysis server 200 is configured by a general server like the object server 100, and is provided with the operation log acquisition unit 201, a case flowchart generation unit 202, a template generation unit 203, an operation flowchart generation unit 204, a controller 205 and a communication device 206. The controller 205 is similar to the controller 102 of the object server 100, and controls operation of each unit in the analysis server 200; the communication device 206 is similar to the communication device 103 of the object server 100, and transmits/receives various information between the object server 100 and the analysis server.

The operation log acquisition unit 201 acquires the operation log stored in the object server 100 at predetermined timing (for example, at night every Saturday or at real time) and outputs the operation log to the case flowchart generation unit 202.

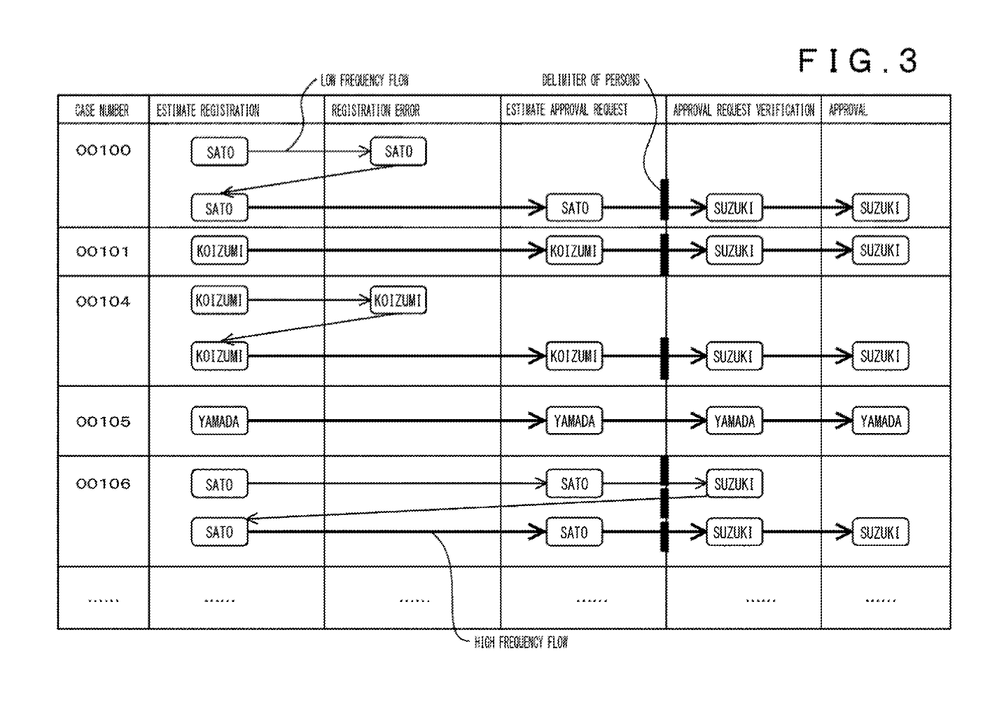

The case flowchart generation unit 202 receives the operation log acquired by the operation log acquisition unit 201 and generates a case flowchart. FIG. 3 shows an example of the case flowchart generated by the case flowchart generation unit 202.

As shown in FIG. 3, in the generated case flowchart, the case number and a screen corresponding to each operation of “ESTIMATE REGISTRATION”, “REGISTRATION ERROR”, “ESTIMATE APPROVAL REQUEST”, “APPROVAL REQUEST VERIFICATION” and “APPROVAL” are correlated and on the abovementioned each screen, the user who operates the screen and performs the operation is recorded. In FIG. 3, for example, the flow of the operation described in the operation log is recorded. A flow from “ESTIMATE REGISTRATION” to “REGISTRATION ERROR” is an irregular case, and since such a case does not occur frequently, the flow is recorded by a thin line; a flow from “ESTIMATE REGISTRATION” to “ESTIMATE APPROVAL REQUEST” and a flow from “APPROVAL VERIFICATION REQUEST” to “APPROVAL” are a flow of a normal operation, and since such a case occurs frequently, the flows are recorded by a thick line. Such thickness of the lines can be suitably determined in such a manner that for example, when a frequency of the flow of the operation is equal to a certain threshold or less, the flow is recorded by the thin line and when the frequency is greater than the certain threshold, the flow is recorded by the thick line. In addition, since the operation from “ESTIMATE REGISTRATION” to “ESTIMATE APPROVAL REQUEST” is performed by one user (Mr. or Ms. Sato) and the operation from “APPROVAL VERIFICATION REQUEST” to “APPROVAL” is performed by another user (Mr. or Ms. Suzuki), a delimiter of the persons is recorded in a boundary between the operations.

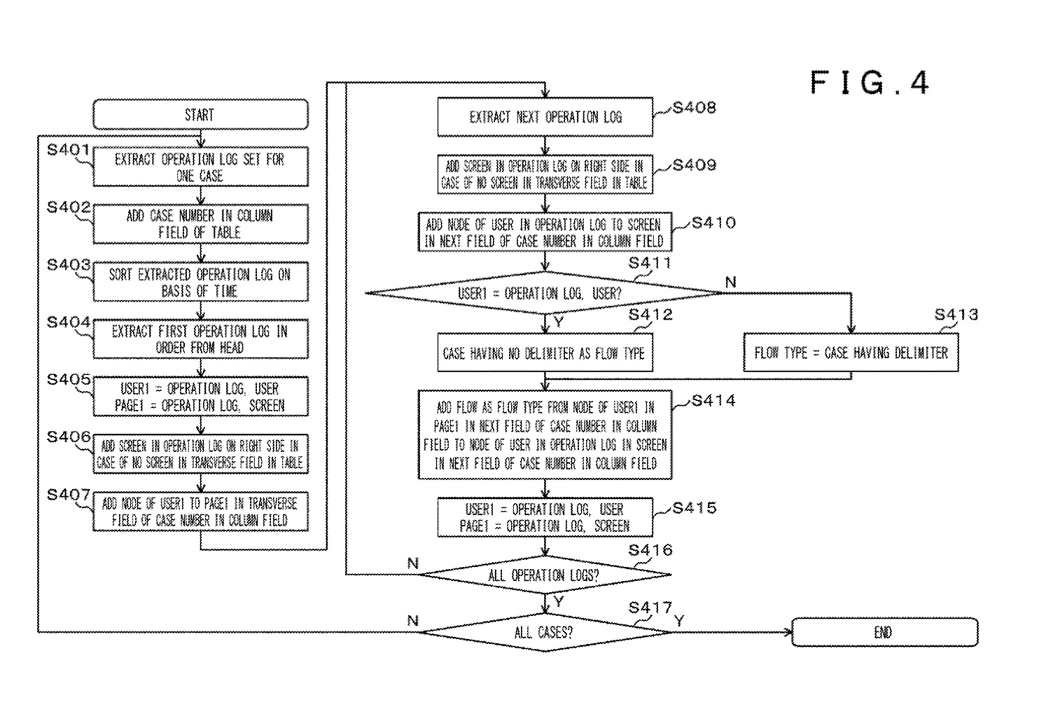

FIG. 4 is a flowchart showing a procedure for a case flowchart generation process for generating the case flowchart. As shown in FIG. 4, first, the case flowchart generation unit 202 extracts an operation log set for one case in the operation log received from the operation log acquisition unit 201 using the case number for a key (S401).

Next, the case flowchart generation unit 202 adds a case number in a column field in a table (the case flowchart shown in FIG. 3) (S402) and sorts the extracted operation log on the basis of time (S403). Further, the case flowchart generation unit 202 extracts the first operation log in order from the head of the sorted operation log (S404), reads the operation log related to a user 1 (USER1) (a value in a user field in the operation log) in the operation log and a screen (PAGE1) of the operation log (a value in a screen field in the operation log) (S405), and generates a field on the right side of the case number by adding a screen on the right side in the case of no screen (for example, “ESTIMATE REGISTRATION”) of the operation log in a transverse field in the table including the case number added in S402 (S406).

The case flowchart generation unit 202 adds a node of USER1 (for example, Mr. or Ms. Sato) in the field of PAGE1 which is generated in S406 and which is the transverse field of the case number in the column (S407) and extracts the next operation log (S408). Further, the case flowchart generation unit 202 generates a field by adding a screen on the right side in the case of no screen (for example, “REGISTRATION ERROR”) of the operation log in the transverse field in the table (S409) and adds a node of USER1 (for example, Mr. or Ms. Sato) in the field of the screen of the operation log of the case number in the column (S407).

The case flowchart generation unit 202 determines whether USER1 is a user of the operation log or not (that is, whether or not the user read in S405 and the user added in S407 and S410 are the same) (S411); when the case flowchart generation unit determines that the users are the same (S411; Yes), it determines that there is no delimiter as a flow type, and the process proceeds to S414 without recording a delimiter of persons though the delimiter of persons is recorded in FIG. 3. In the meantime, the case flowchart generation unit 202 determines that a delimiter as a flow type is required when it determines that the users are not the same (S411; No), a delimiter of persons is recorded as shown in FIG. 3, and the process proceeds to S414.

The case flowchart generation unit 202 adds a flow (a line) as a flow type from the node of USER1 added in S407 to PAGE1 for the case number to the node of the user added in S410 on the screen of the operation log (S414) and reads the next USER1 (a value of the user field of the operation log and the next PAGE1 (a value in the screen filed of the operation log) (S416). In this case, “Sato” shown on the downside of “Sato” added in S407 is read.

The case flowchart generation unit 202 determines whether or not the steps S408 to S415 are finished as to all operation logs for one case (S416), and when the case flowchart generation unit determines that the steps S408 to S415 are not finished (S416; No), the process is returned to S408 and the following steps are repeated. In the meantime, the case flowchart generation unit 202 further determines whether steps of all cases are finished or not (S417) when the case flowchart generation unit determines that the steps S408 to S415 are finished (S416; Yes), the case flowchart generation unit returns the process to S401 when it determines that all the steps are not finished (S417; No), and the case flowchart generation unit repeats the following steps. In the meantime, when the case flowchart generation unit 202 determines that all the steps are finished (S417; Yes), it finishes this case flowchart generation process. The case flowchart shown in FIG. 3 is generated by repeatedly executing the case flowchart generation process as described above. Next, the template generation unit 203 will be described.

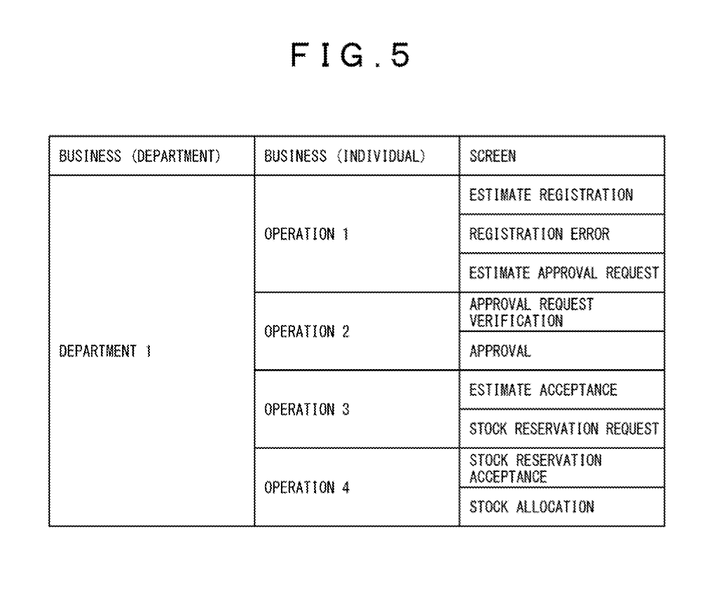

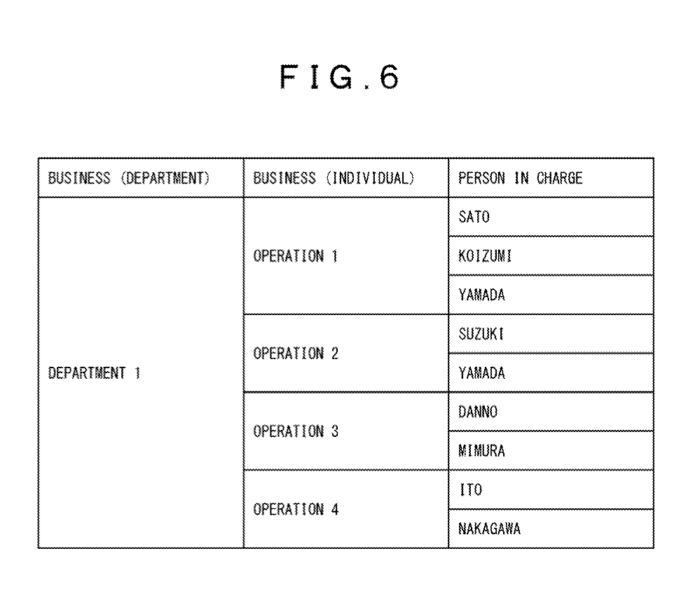

The template generation unit 203 generates an operation hierarchy chart template showing relation between a department and an operation and a department chart template showing department hierarchy showing relation between the department and persons in charge, according to the case flowchart generated by the case flowchart generation unit 202. FIG. 5 shows an example of the operation hierarchy chart template generated by the template generation unit 203. In addition, FIG. 6 shows an example of the department chart template generated by the template generation unit 203.

As shown in FIG. 5, in the operation hierarchy chart template, an operation executed in the organization, an operation executed by an individual in the department and a screen used in the operation executed by the individual are correlated. FIG. 5 shows that in an operation 1 out of operations executed in a department 1, “ESTIMATE REGISTRATION”, “REGISTRATION ERROR” and “ESTIMATE APPROVAL REQUEST” are included, and in an operation 2, “APPROVAL VERIFICATION REQUEST” and “APPROVAL” are included.

The template generation unit 203 records “ESTIMATE REGISTRATION”, “REGISTRATION ERROR” and “ESTIMATE APPROVAL REQUEST” as an operation hierarchy chart template by reading the case flowchart generated in the case flowchart generation process shown in FIG. 4, judging that for a certain operation, “ESTIMATE REGISTRATION”, “REGISTRATION ERROR” and “ESTIMATE APPROVAL REQUEST” before a location in which a delimiter of persons is recorded are one operation, and correlating the one operation to the operation 1. Similarly, the template generation unit 203 judges that “APPROVAL VERIFICATION REQUEST” and “APPROVAL” after the location in which the delimiter of persons is recorded are one operation, correlates the one operation to the operation 2, records “APPROVAL VERIFICATION REQUEST” and “APPROVAL” as an operation hierarchy chart template.

In addition, as shown in FIG. 6, in the department chart template, an operation executed by an organization, an operation executed by an individual in the department and the individual which is a person in charge are correlated. FIG. 6 shows that in the operation 1 out of operations performed in the department 1, Mrs. or Mses. Sato, Koizumi and Yamada are in charge and in the operation 2, Mrs. or Mses. Suzuki and Yamada are in charge.

The template generation unit 203 reads the operation hierarchy chart template and the case flowchart generated in the case flowchart generation process shown in FIG. 4, reads the department chart template, records Mrs. or Mses. Sato, Koizumi and Yamada who are persons included in the operation judged as one operation before the location in which the delimiter of persons is recorded with them correlated to the operation 1, and records Mrs. or Mses. Suzuki and Yamada who are persons included in the operation judged as one operation after the location in which the delimiter of persons is recorded to the operation 2 with them correlated with the operation 2 in the department chart template.

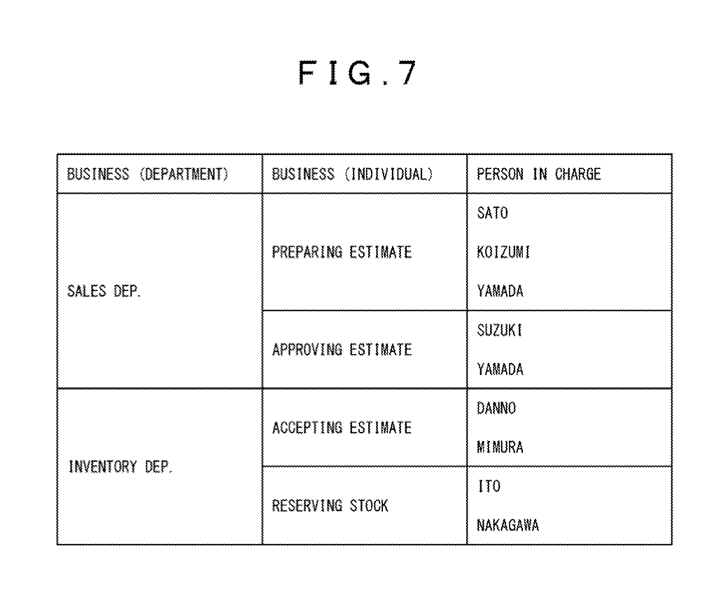

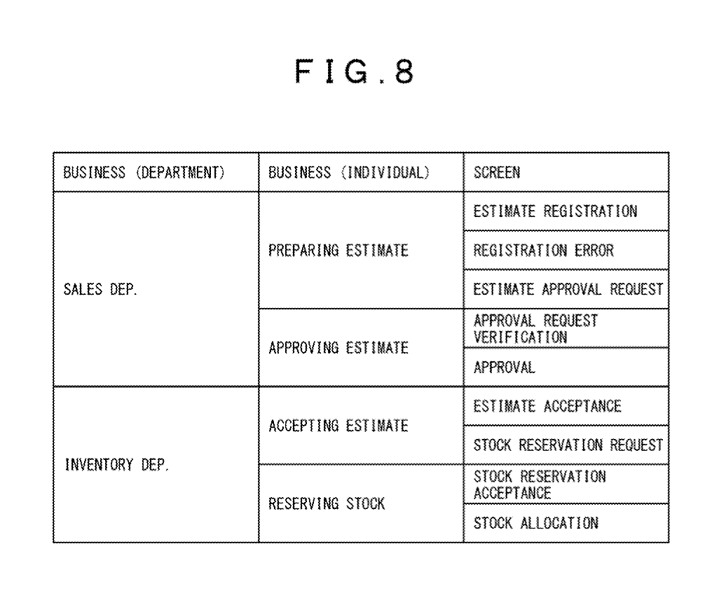

Further, the template generation unit 203 reads department data correlating a predetermined department chart and an operation in charge in a department (for example, data acquired by correlating the operations 1, 2 and Sales dep. which is the department 1 as a department in charge) and generates such a department chart template and such an operation hierarchy chart template respectively as shown in FIGS. 7 and 8 and recording concrete departments in charge. At this time, the template generation unit 203 judges a common meaning of contents (for example, “ESTIMATE REGISTRATION”, “REGISTRATION ERROR” and “ESTIMATE APPROVAL REQUEST”) recorded in a screen field corresponding to business (an individual) in the operation hierarchy chart template and determines a name of the business (the individual). For example, when the contents recorded in the screen field are “ESTIMATE REGISTRATION”, “REGISTRATION ERROR” and “ESTIMATE APPROVAL REQUEST”, the template generation unit judges the business to be business of preparing an estimate. Similarly, as for the operation 2, the template generation unit judges a common meaning of “APPROVAL REQUEST VERIFICATION” and “APPROVAL” and judges the business (the individual) to approve the estimate. Next, the operation flowchart generation unit 204 will be described.

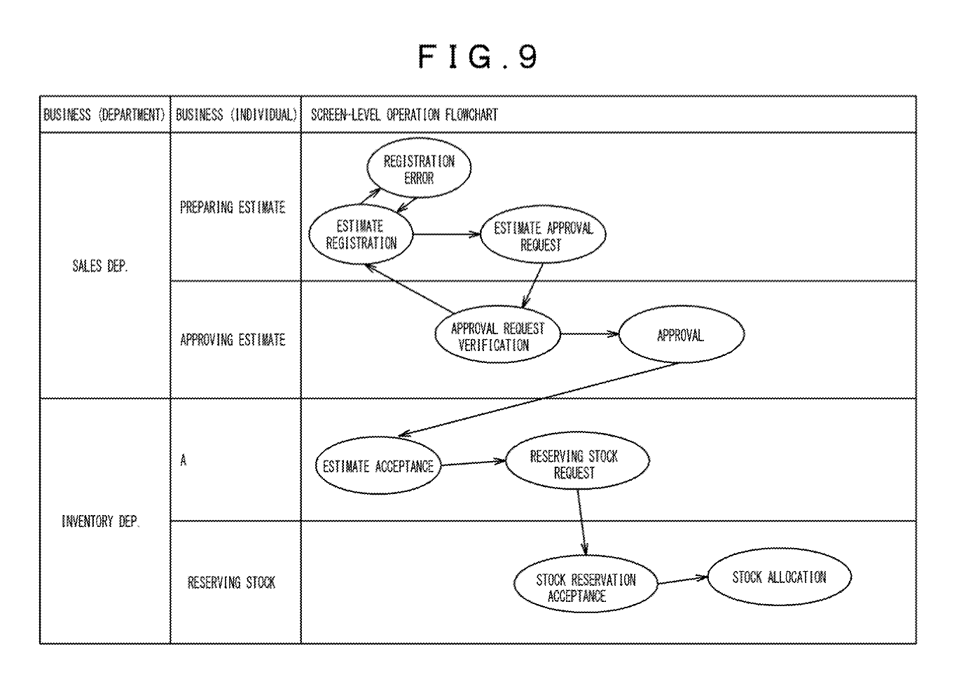

The operation flowchart generation unit 204 reads the case flowchart shown in FIG. 3, the department chart template shown in FIG. 7 (or FIG. 6) and the operation hierarchy chart template shown in FIG. 8 (or FIG. 5), and generates a screen-level operation flowchart. FIG. 9 shows an example of the screen-level operation flowchart. As shown in FIG. 9, in the screen-level operation flowchart, the department in charge of the operation, the individual in charge to execute the operation and an operation flow at a screen level are recorded with them correlated. In FIG. 9, each screen in the case flowchart shown in FIG. 2, each operation executed on the screen and each line (a thin line and a thick line) showing a flow of the operation are correlated, and the screen-level operation flowchart is generated for each department and each individual.

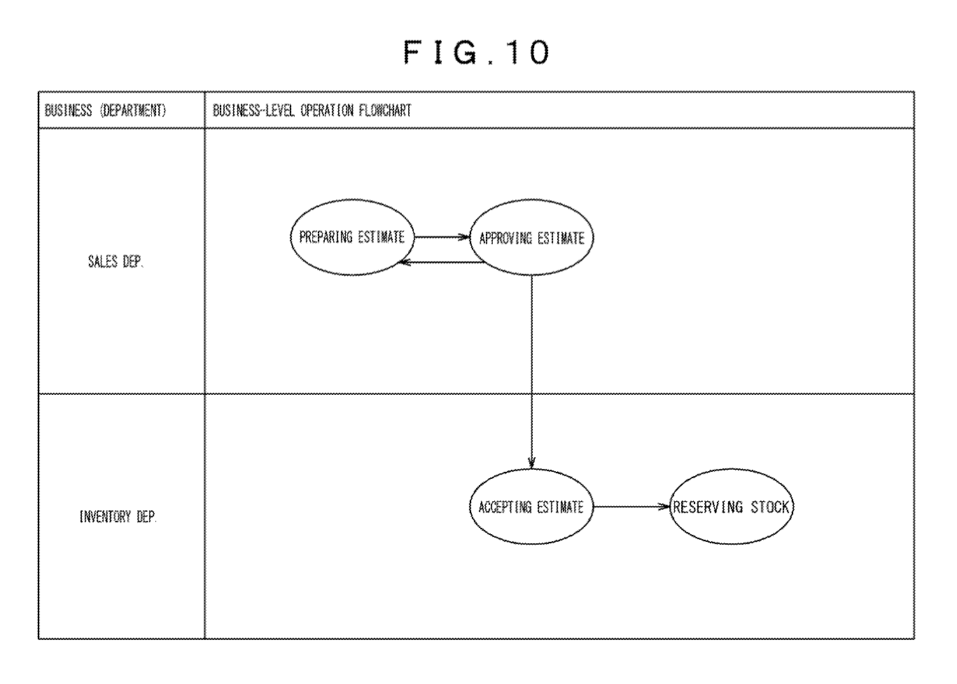

Further, the operation flowchart generation unit 204 reads the screen-level operation flowchart and generates an operation-level operation flowchart on the basis of the screen-level operation flowchart. FIG. 10 shows an example of the operation-level operation flowchart. As shown in FIG. 10, in the operation-level operation flowchart, the department in charge of the operation and an operation-level operation flowchart are recorded with them correlated. In FIG. 10, the operation-level operation flowchart is generated every operation of the individual in charge shown in FIG. 9.

As described above, in this system, the operation flowchart is generated by executing the abovementioned processing, and therefore interactions among the organization, role-level persons and the system can be extracted from a log of the system such as an operation log. For example, a case flowchart for one case is generated on the basis of an operation log of an application including time, user ID, screen ID and case ID, and a point at which persons are switched at a certain rate is specified on the basis of a delimiter of persons in the case flowchart. Hereby, a list of screen transition performed by one person can be extracted as an operation. In addition, the operation flowcharts (screen-level and operation-level) can be generated on the basis of the extracted information. Accordingly, a set of meaningful screens in operations which could not be extracted according to the related art disclosed in Patent Literature 1 can be specified. Moreover, when required information exists in an operation log, the information can be extracted even if the information is different in a form of a document as in the related art disclosed in Patent Literature 2. Consequently, since specifications of operations realized in the system can be reproduced in the shape of the operation flowcharts from an operation log of the former system, business requirements of the former system which were heretofore acquired by ordinary hearing and others can be acquired on the basis of information matched with the present situation. In addition, it is better as to the processing (the analysis) in the analysis server 200 to execute processing except operation on a specific screen. For example, characteristics can be more readily extracted by removing operation on a screen utilized by many users such as a menu screen.

The present invention is not limited to the abovementioned embodiment and various variations are included. For example, the abovementioned embodiment is described in detail to make the present invention easy to understand, and the abovementioned embodiment is not necessarily provided with described all configuration. In addition, a part of a certain embodiment can be replaced with a configuration of another embodiment, and in addition, a configuration of another embodiment can also be added to a configuration of a certain embodiment. Moreover, another configuration can be added, deleted or replaced to/from/with a part of the configuration of each embodiment.

### LIST OF REFERENCE SIGNS

1000 Operation specification reproduction system
100 Object server
101 Storage
102 Controller
103 Communication device
200 Analysis server
201 Operation log acquisition unit
202 Case flowchart generation unit
203 Template generation unit
204 Operation flowchart generation unit
205 Controller
206 Communication device
N Network

1. An operation specification reproduction system, comprising:
a case flowchart generation unit that generates a case flowchart showing a flow of an operation performed by persons in charge in a case on the basis of operation log data recording operations of each person in charge in the operation required for executing the case;
a template generation unit that generates an operation hierarchy template showing relation between a department and the operation and a department template showing relation between the department and the persons in charge on the basis of department data correlating the department of the operation and the operation and the case flowchart generated by the case flowchart generation unit; and
an operation flowchart generation unit that generates an operation flowchart showing a flow of the operation of each department on the basis of the operation hierarchy template and the department template respectively generated by the template generation unit.

2. The operation specification reproduction system according to claim 1,
wherein the case flowchart generation unit generates a case flowchart showing a flow of the operation of each screen for performing the operation correlated with the operation;
the template generation unit generates the operation hierarchy template on the basis of the case flowchart and the department data; and
the operation flowchart generation unit generates the operation flowchart at a level of the screen on the basis of the operation hierarchy template and the department template.

3. The operation specification reproduction system according to claim 1,
wherein the case flowchart generation unit records a boundary between operations where the person in charge is replaced by another in the generated case flowchart and judges the operation to the boundary as the operation of the former person in charge; and
the template generation unit judges the operations of the persons in charge on the basis of the department data and the case flowchart recording the boundary and generates the operation hierarchy template.

4. An operation specification reproduction method, comprising:
a case flowchart generation step of generating a case flowchart showing a flow of operations performed by persons in charge in a case on the basis of operation log data recording operations of each person in charge in the operations required for executing the case;
a template generation step of generating an operation hierarchy template showing relation between a department and the operations and a department template showing relation between the department and the persons in charge on the basis of department data correlating the department of the operations with operations and the case flowchart generated in the case flowchart generation step; and
an operation flowchart generation step of generating an operation flowchart showing a flow of the operations of each department on the basis of the operation hierarchy template and the department template respectively generated in the template generation step.

5. The operation specification reproduction method according to claim 4,
wherein in the case flowchart generation step, a case flowchart showing a flow of the operations is generated for each screen for performing the operation correlated with the operation;
in the template generation step, the operation hierarchy template is generated on the basis of the case flowchart and the department data; and
in the operation flowchart generation step, the operation flowchart at a level of the screen is generated on the basis of the operation hierarchy template and the department template.

6. The operation specification reproduction method according to claim 4,
wherein in the case flowchart generation step, a boundary of operations where the person in charge is replaced by another in the generated case flowchart is recorded and the operation to the boundary is judged as the operation of the former person in charge; and
in the template generation step, the operations of the persons in charge are judged on the basis of the department data and the case flowchart recording the boundary and the operation hierarchy template is generated.
